(19) United States
(12) Patent Application Publication
(10) Pub. No.: US 2026/0145487 A1
(43) Pub. Date: May 28, 2026

(54) HEAT MANAGEMENT SYSTEM FOR VEHICLE

(71) Applicant: Hanon Systems, Daejeon (KR)

(72) Inventors: Jae Min LEE, Daejeon (KR); In Keun KANG, Daejeon (KR); Young Man KIM, Daejeon (KR); In Hyeok KIM, Daejeon (KR); Jae Kyun KIM, Daejeon (KR); Kyeong Cheol LEE, Daejeon (KR); Chan Jin LEE, Daejeon (KR)

(73) Assignee: Hanon Systems, Daejeon (KR)

(21) Appl. No.: 19/121,724

(22) PCT Filed: Oct. 10, 2023
(86) PCT No.: PCT/KR2023/015506

§ 371 Date: Apr. 16, 2025

(30) Foreign Application Priority Data
Nov. 11, 2022 (KR) 10-2022-0150820

(51) Int. Cl. B60H 1/32; B60H 1/00; B60H 1/14

(52) U.S. Cl. CPC B60H 1/3228; B60H 1/00899; B60H 1/143; B60H 2001/3269

(57) ABSTRACT

A vehicular heat management system configured to adjust the amount of refrigerant distributed to an outdoor heat exchanger and a chiller depending an air conditioning conditions in a heat pump mode is disclosed, which allows reduction of unnecessary refrigerant flow path resistance and pressure loss due to distribution of refrigerant to an unnecessary part and resultant decrease in heat pump performance by limiting the distribution of the refrigerant to an unnecessary part among the outdoor heat exchanger and the chiller depending on the conditions. The system includes: a heat pump type refrigerant circulation line including a compressor, a high pressure side heat exchanger, and an outdoor heat exchanger and a chiller connected in parallel to each other; and a refrigerant distribution amount control part configured to control an amount of refrigerant distributed to the outdoor heat exchanger and the chiller according to air conditioning conditions in a heat pump mode.

### TECHNICAL FIELD

The present invention relates to a vehicular heat management system, and more particularly, a vehicular heat management system configured to adjust the amount of refrigerant distributed to an outdoor heat exchanger and a chiller depending an air conditioning conditions in a heat pump mode, so that it is possible to reduce unnecessary refrigerant flow path resistance and pressure loss due to the distribution of refrigerant to an unnecessary part and resultant decrease in heat pump performance by limiting the distribution of the refrigerant to an unnecessary part among the outdoor heat exchanger and the chiller depending on the conditions.

### BACKGROUND ART

Examples of eco-friendly vehicles include an electric vehicle, a hybrid vehicle, and a fuel cell vehicle (hereinafter collectively referred to as “vehicle”).

Such a vehicle is equipped with an air conditioner 10 that cools and heats an air conditioning region as shown in FIG. 1.

The air conditioner 10 is of a heat pump type and includes a refrigerant circulation line 12.

The refrigerant circulation line 12 includes a compressor 14, a high-pressure side heat exchanger 16, an outdoor heat exchanger 18, a plurality of low-pressure side heat exchangers 20 installed in parallel with each other, an expansion valve 18a installed on the upstream side of the outdoor heat exchanger 18, and a plurality of expansion valves 22 and 24 installed on the upstream side of the respective low-pressure side heat exchangers 20.

The low-pressure side heat exchangers 20 include a vehicle interior cooling heat exchanger 20a for cooling the vehicle interior, and an electrical component cooling chiller 20b (hereinafter referred to as “chiller”) for cooling a battery and electrical component modules (hereinafter collectively referred to as “electrical components”).

The chiller 20b is installed on a branch line 12a branched from the upstream portion of an expansion valve 18a on the side of the outdoor heat exchanger 18. The chiller 20b is installed in parallel with the outdoor heat exchanger 18.

In particular, the chiller 20b installed in parallel with the outdoor heat exchanger 18 introduces refrigerant together with the outdoor heat exchanger 18 in the heat pump mode for heating the vehicle interior.

The chiller 20b causes the refrigerant in the branch line 12a to exchange heat with the cooling water in a cooling water circulation line 24 for cooling electric components.

Accordingly, the waste heat of the electrical components absorbed to the cooling water in the cooling water circulation line 24 can be recovered to the refrigerant in the branch line 12a. This can improve the heat pump mode efficiency of the air conditioner 10.

Meanwhile, in the heat pump mode, the outdoor heat exchanger 18, which has introduced the refrigerant together with the chiller 20b, recovers the ambient air heat by allowing the introduced refrigerant to exchange heat with the ambient air.

Therefore, in cooperation with the chiller 20b, the outdoor heat exchanger improves the heat pump mode efficiency by increasing the waste heat recovery efficiency of the refrigerant returning to the compressor 14 side.

However, such a conventional air conditioner 10 has a disadvantage in that, in the heat pump mode, during the process of distributing the refrigerant to both the outdoor heat exchanger 18 and the chiller 20b, the distribution of the refrigerant is determined only by the refrigerant pressure loss in each of the outdoor heat exchanger 18 and the chiller 20b, which makes it impossible to adjust the amount of the refrigerant distributed to the outdoor heat exchanger 18 and the chiller 20b as needed.

In particular, in order to enhance the efficiency of the heat pump mode, it is necessary to control the refrigerant distribution to both the outdoor heat exchanger 18 and the chiller 20b depending on the conditions.

For example, if the heat recovery rate for the electrical components on the chiller 20b side is sufficiently greater than a preset value, it is necessary to restrict the distribution of the refrigerant to the outdoor heat exchanger 18 and allow the distribution of the refrigerant only to the chiller 20b, thereby preventing unnecessary refrigerant flow path resistance and pressure loss due to the distribution of the refrigerant to the outdoor heat exchanger 18 and the resulting decrease in heating performance.

In addition, when icing occurs on the surface of the outdoor heat exchanger 18, it is necessary to limit the distribution of the refrigerant to the outdoor heat exchanger 18 to prevent occurrence of icing on the outdoor heat exchanger 18.

However, as in the past, the structure in which the distribution of the refrigerant flow to the outdoor heat exchanger 18 and the chiller 20b is determined only by the refrigerant pressure loss has a disadvantage in that it cannot respond to the need to control the refrigerant distribution to the outdoor heat exchanger 18 and the chiller 20b according to the conditions and status of the refrigerant.

Due to these shortcomings, there are problems such as unnecessary flow path resistance and pressure loss, and icing occurring in the outdoor heat exchanger 18, as a result of which the efficiency and heating performance of the heat pump mode are significantly reduced.

### DETAILED DESCRIPTION OF THE INVENTION

### Technical Task

The present invention has been made to solve the above-mentioned problems of the prior art, and it is an object of the present invention to provide a vehicular heat management system capable of adjusting the amount of refrigerant distributed to an outdoor heat exchanger and a chiller depending an air conditioning conditions in a heat pump mode.

Another object of the present invention is to provide a vehicular heat management system capable of suppressing the distribution of refrigerant to an unnecessary part among an outdoor heat exchanger and a chiller depending on conditions by adjusting the amount of refrigerant distributed to the outdoor heat exchanger and the chiller depending on conditions in a heat pump mode.

A further object of the present invention is to provide a vehicular heat management system capable of preventing unnecessary refrigerant flow path resistance and pressure loss due to refrigerant distribution to an unnecessary part and resulting decrease in heat pump performance by suppressing the distribution of refrigerant to an unnecessary part among an outdoor heat exchanger and a chiller depending on conditions.

### Means to Solve the Task

In order to achieve these objects, the present invention provides a vehicular heat management system, including: a heat pump type refrigerant circulation line including a compressor, a high pressure side heat exchanger, and an outdoor heat exchanger and a chiller connected in parallel to each other; and a refrigerant distribution amount control part configured to control an amount of refrigerant distributed to the outdoor heat exchanger and the chiller according to air conditioning conditions in a heat pump mode.

The chiller may be configured to, in the heat pump mode, allow the refrigerant in the refrigerant circulation line to exchange heat with cooling water in a cooling water circulation line for cooling electrical components, so that waste heat of the electrical components absorbed to the cooling water is recovered to the refrigerant in the refrigerant circulation line, and the refrigerant distribution amount control part may be configured to, in the heat pump mode, variably control the amount of refrigerant distributed to the outdoor heat exchanger and the chiller according to a waste heat recovery rate of the refrigerant for the electrical components on the chiller side.

The system may further include: a waste heat recovery rate sufficient condition determination part configured to, in the heat pump mode, determine whether the waste heat recovery rate of the refrigerant for the electrical components on the chiller side is sufficient and equal to or greater than a preset value or insufficient and smaller than the preset value, wherein the refrigerant distribution amount control part may be configured to, in the heat pump mode, variably control the refrigerant distribution to the outdoor heat exchanger and the chiller according to a result of determination by the waste heat recovery rate sufficient condition determination part as to whether the waste heat recovery rate of the refrigerant for the electrical components on the chiller side is sufficient or insufficient.

If the waste heat recovery rate sufficient condition determination part determines that the waste heat recovery rate of the refrigerant for the electrical components on the chiller side is sufficient, the refrigerant distribution amount control part may restrict the refrigerant distribution to the outdoor heat exchanger and may permit the refrigerant distribution to the chiller, so that only the waste heat recovery from the electrical components on the chiller side is performed while restricting the air heat recovery from ambient air on the outdoor heat exchanger side.

If the waste heat recovery rate sufficient condition determination part determines that the waste heat recovery rate of the refrigerant for the electrical components on the chiller side is insufficient, the refrigerant distribution amount control part may simultaneously permit the refrigerant distribution to the outdoor heat exchanger and the refrigerant distribution to the chiller, so that the waste heat recovery from the electrical components on the chiller side and the air heat recovery from the ambient air on the outdoor heat exchanger side are performed at the same time.

The system may further include: an expansion valve configured to depressurizing and expanding the refrigerant introduced into the outdoor heat exchanger in the heat pump mode, wherein when distributing the refrigerant to the outdoor heat exchanger under the condition that the waste heat recovery rate of the refrigerant for the electrical components on the chiller side is insufficient, the refrigerant distribution amount control part may variably control an opening degree of the expansion valve on the outdoor heat exchanger side according to a refrigerant superheat degree of at an outlet of the outdoor heat exchanger.

The refrigerant distribution amount control part may increase the opening degree of the expansion valve by a preset value when the refrigerant superheat degree at the outlet of the outdoor heat exchanger exceeds the preset target superheat degree, and may decrease the opening degree of the expansion valve by a preset value when the refrigerant superheat degree at the outlet of the outdoor heat exchanger is smaller than the preset target superheat degree.

The system may further include: an icing occurrence determination part configured to determine whether icing occurs on a surface of the outdoor heat exchanger in the heat pump mode, wherein when the icing occurrence determination part determines that icing occurs on the surface of the outdoor heat exchanger in the heat pump mode, the refrigerant distribution amount control part may restrict the refrigerant distribution to the outdoor heat exchanger and may permit the refrigerant distribution to the chiller so as to prevent icing occurrence on the outdoor heat exchanger.

### Effect of the Invention

According to the vehicular heat management system of the present invention, in the heat pump mode, the amount of refrigerant distributed to the outdoor heat exchanger and the chiller can be adjusted depending on the state of the refrigerant and the air conditioning conditions. Therefore, the distribution of the refrigerant to an unnecessary part among the outdoor heat exchanger and the chiller can be restricted depending on the conditions.

In particular, under conditions where the waste heat recovery rate for the electrical components on the chiller side is sufficient, refrigerant distribution to the outdoor heat exchanger is restricted, and refrigerant distribution only to the chiller is permitted. Therefore, unnecessary refrigerant distribution to the outdoor heat exchanger can be prevented when the waste heat recovery rate for the electrical components on the chiller side is sufficient.

In addition, when the heat recovery rate for the electrical components on the chiller side is sufficient, it is possible to prevent unnecessary refrigerant distribution to the outdoor heat exchanger. Therefore, the unnecessary refrigerant flow path resistance and pressure loss due to unnecessary refrigerant distribution to the outdoor heat exchanger and the resulting decrease in heating performance can be suppressed.

In addition, in the heat pump mode, under the condition of occurrence of icing on the surface of the outdoor heat exchanger, the distribution of refrigerant to the outdoor heat exchanger is restricted, and the distribution of refrigerant to the chiller is permitted. Therefore, when icing occurs on the surface of the outdoor heat exchanger, the flow of refrigerant to the outdoor heat exchanger side is restricted, thereby fundamentally preventing the occurrence of icing on the outdoor heat exchanger.

### BRIEF DESCRIPTION OF THE DRAWINGS

FIG. 1 is a view showing a conventional vehicular heat management system.

FIG. 2 is a view showing a vehicular heat management system according to an embodiment of the present invention.

FIG. 3 is an operation diagram showing an operation example of the vehicular heat management system according to the present invention, which shows an operation example when the waste heat recovery rate for electrical components on the chiller side is sufficient in a heat pump mode.

FIG. 4 is an operation diagram showing an operation example of the vehicular heat management system according to the present invention, which shows an operation example when the waste heat recovery rate for electrical components on the chiller side is insufficient in a heat pump mode.

FIG. 5 is an operation diagram showing an operation example of the vehicular heat management system according to the present invention, which shows an operation example when icing occurs on the surface of an outdoor heat exchanger under a condition in which the waste heat recovery rate for electrical components on the chiller side is insufficient in the heat pump mode.

FIGS. 6 and 7 are flowcharts showing an operation example of the vehicular heat management system according to the present invention.

FIG. 8 is a diagram showing a vehicular heat management system according to another embodiment of the present invention.

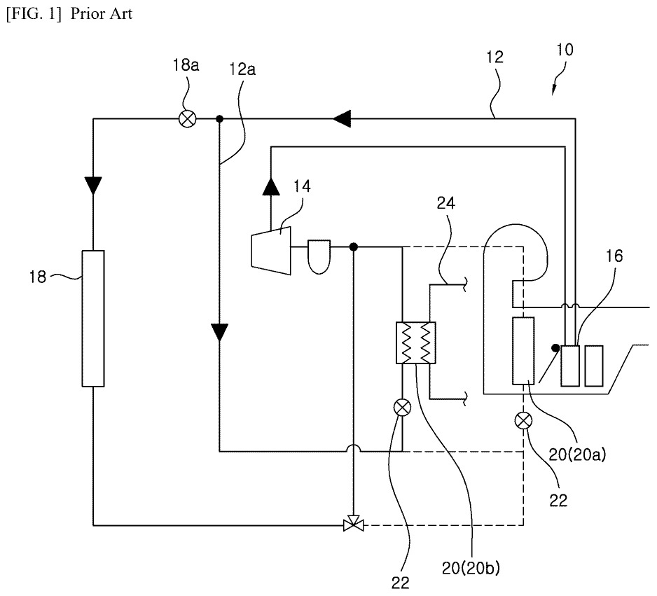

### BEST MODE TO IMPLEMENT THE INVENTION

Hereinafter, a preferred embodiment of a vehicular heat management system according to the present invention will be described in detail with reference to the accompanying drawings. The same components as those of the above-described prior art will be designated by the same reference numerals.

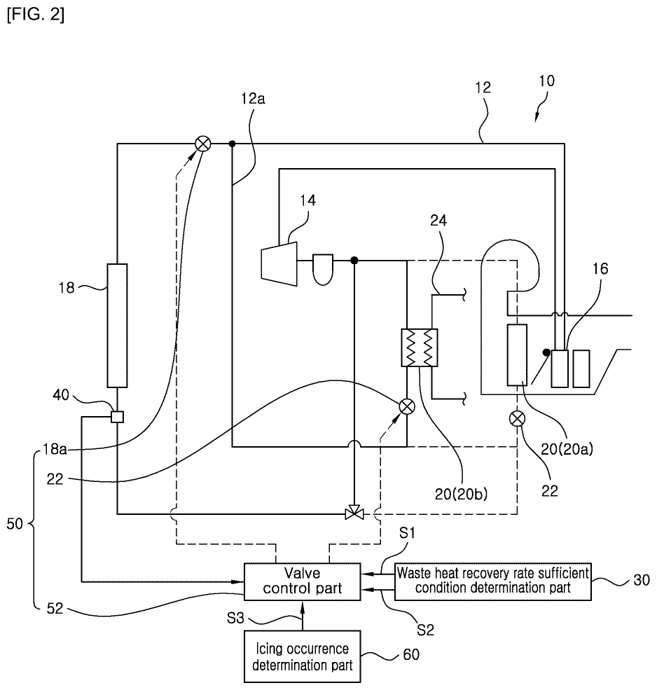

First, prior to describing the features of the vehicular heat management system according to the present invention, the general aspect of the vehicular heat management system will be briefly described with reference to FIG. 2.

The vehicular heat management system is equipped with an air conditioner 10 that cools and heats an air conditioning region. The air conditioner 10 is of a heat pump type and includes a refrigerant circulation line 12.

The refrigerant circulation line 12 includes a compressor 14, a high-pressure side heat exchanger 16, an outdoor heat exchanger 18, a plurality of low-pressure side heat exchangers 20 installed in parallel with each other, an expansion valve 18a installed on the upstream side of the outdoor heat exchanger 18, and a plurality of expansion valves 22 installed on the upstream side of the respective low-pressure side heat exchangers 20.

The low-pressure side heat exchangers 20 include a vehicle interior cooling heat exchanger 20a for cooling the vehicle interior, and a chiller 20b for cooling electrical components.

The chiller 20b is installed on a branch line 12a branched from the upstream side of the expansion valve 18a on the outdoor heat exchanger 18 side. The chiller 20b is installed in parallel with the outdoor heat exchanger 18.

the chiller 20b introduces refrigerant together with the outdoor heat exchanger 18 in the heat pump mode for heating the vehicle interior. The chiller 20b causes the introduced refrigerant to exchange heat with the cooling water in a cooling water circulation line 24 for cooling electric components.

Accordingly, the waste heat of the electrical components absorbed to the cooling water in the cooling water circulation line 24 can be recovered to the refrigerant in the branch line 12a.

Meanwhile, the outdoor heat exchanger 18, which has introduced the refrigerant together with the chiller 20b, recovers the ambient air heat by allowing the introduced refrigerant to exchange heat with the ambient air.

Therefore, in cooperation with the chiller 20b, the outdoor heat exchanger improves the heat pump mode efficiency by increasing the waste heat recovery efficiency of the refrigerant returning to the compressor 14 side.

Next, the features of the vehicular heat management system according to an embodiment of the present invention will be described in detail with reference to FIGS. 2 to 6.

Referring to FIG. 2, the vehicular heat management system according to the present invention includes a waste heat recovery rate sufficient condition determination part 30 that determines whether the waste heat recovery rate of refrigerant for electrical components on the chiller 20b side is sufficient and equal to or greater than a preset value or insufficient and smaller than the preset value in the heat pump mode.

The waste heat recovery rate sufficient condition determination part 30 is equipped with a microprocessor and, in the heat pump mode, receives refrigerant temperature T1 and an outside air temperature T2, which are factors affecting the waste heat recovery rate for electrical components on the chiller 20b side, from a PT sensor 40 at the outlet of the outdoor heat exchanger 18 and an outside air sensor (not shown), respectively.

The refrigerant temperature T1, the outside air temperature T2, and a preset waste heat recovery rate determination reference temperature difference T3 are compared. Determination as to whether the waste heat recovery rate for electric components on the chiller 20b side is sufficient and equal to or greater than the preset value or insufficient and smaller than the preset value is made depending on whether preset conditions are all satisfied.

That is, it is determined whether a [first condition] that the refrigerant temperature T1 at the outlet of the outdoor heat exchanger 18 is equal to or higher than the outside air temperature T2 as denoted below and a [second condition] that a temperature difference between the refrigerant temperature T1 at the outlet of the outdoor heat exchanger 18 and the outside air temperature T2 is equal or greater than a preset waste heat recovery rate determination reference temperature difference T3 as denoted below are satisfied.

### First Condition

Outdoor heat exchanger outlet refrigerant temperature T1≥outside air temperature T2

### Second Condition

Outdoor heat exchanger outlet refrigerant temperature T1−outside air temperature T2≥waste heat recovery rate determination reference temperature difference T3

If the [first condition] and the [second condition] are all satisfied, the waste heat recovery rate sufficient condition determination part 30 determines that the waste heat recovery rate for electrical components on the chiller 20b side is sufficient and equal to or greater than the preset value in view of the fact that the refrigerant temperature at the outlet of the outdoor heat exchanger 18 is currently higher than the outside air temperature by a preset value or more, and outputs a waste heat recovery rate sufficient signal S1 based on this determination.

On the other hand, if either of the [first condition] and the [second condition] is not satisfied, the waste heat recovery rate sufficient condition determination part 30 determines that the waste heat recovery rate for electrical components on the chiller 20b side is currently insufficient and smaller than the preset value, and outputs a waste heat recovery rate insufficient signal S2 based on this determination.

The vehicular heat management system according to the present invention further includes a refrigerant distribution amount control part 50 that controls the amount of refrigerant distributed to the outdoor heat exchanger 18 and the chiller 20b according to the degree of the waste heat recovery rate for electrical components on the chiller 20b side in the heat pump mode.

In the heat pump mode, the refrigerant distribution amount control part 50 controls the amount of refrigerant distributed to the outdoor heat exchanger 18 and the chiller 20b according to the condition of the waste heat recovery rate for electrical components on the chiller 20b side determined by the waste heat recovery rate sufficient condition determination part 30.

To explain this in more detail, the refrigerant distribution amount control part 50 includes an electromagnetic expansion valve (EXV) 18a installed on the upstream side of the outdoor heat exchanger 18, an electromagnetic expansion valve (EXV) 22 installed on the upstream side of the chiller 20b, and a valve control part 52 that controls the expansion valves 18a and 22.

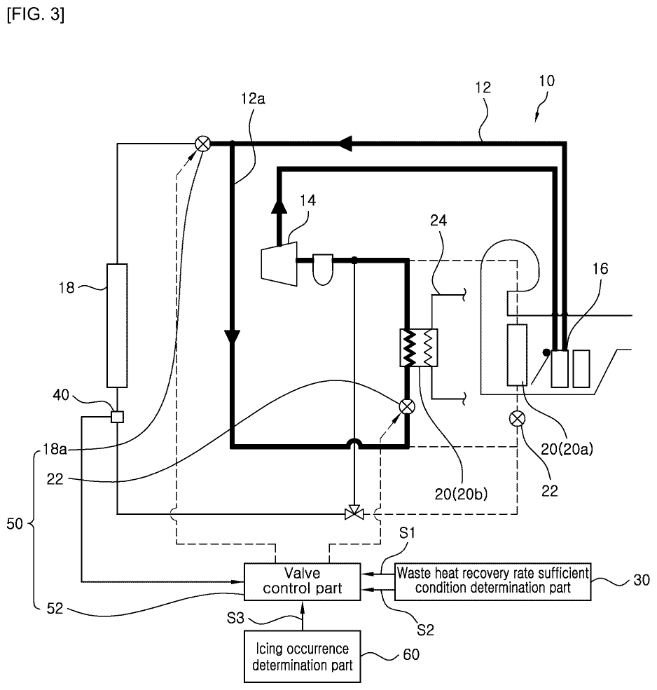

As shown in FIG. 3, when the waste heat recovery rate for electrical components on the chiller 20b side is sufficient in the heat pump mode, the expansion valve 18a on the outdoor heat exchanger 18 side is closed and the expansion valve 22 on the chiller 20b side is opened.

Therefore, when the waste heat recovery rate for electrical components on the chiller 20b side is sufficient in the heat pump mode, the distribution of refrigerant to the outdoor heat exchanger 18 side is restricted, and the distribution of refrigerant to the chiller 20b side is permitted.

Accordingly, when the waste heat recovery rate for electrical components on the chiller 20b side is sufficient in the heat pump mode, only the recovery of waste heat from the electrical components on the chiller 20b side is permitted, and the air heat recovery from the ambient air on the outdoor heat exchanger 18 side is restricted.

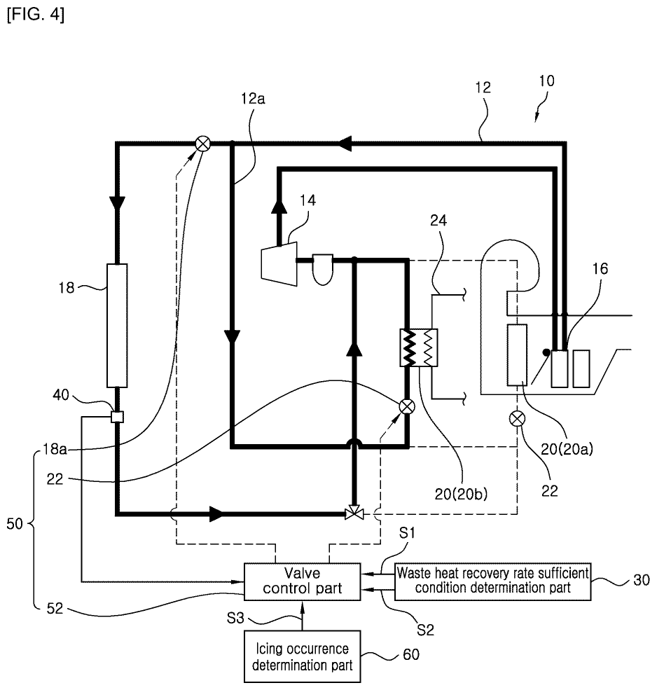

When the waste heat recovery rate for electrical components on the chiller 20b side is insufficient in the heat pump mode, the expansion valves 18a and 22 are opened at a certain opening degree as shown in FIG. 4, thereby allowing the refrigerant to be distributed to the outdoor heat exchanger 18 and the chiller 20b simultaneously.

Therefore, when the waste heat recovery rate for electrical components on the chiller 20b side is insufficient in the heat pump mode, the recovery of waste heat from the electrical components on the chiller 20b side and the air heat recovery from the ambient air on the outdoor heat exchanger 18 side can be performed simultaneously.

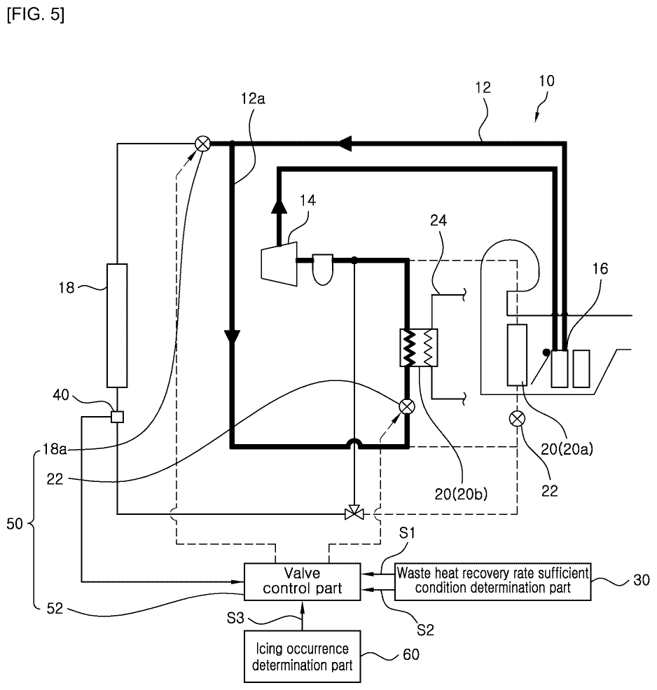

When icing occurs on the surface of the outdoor heat exchanger 18 in the heat pump mode, as shown in FIG. 5, the expansion valve 18a on the outdoor heat exchanger 18 side is closed and the expansion valve 22 on the chiller 20b side is opened, allowing the refrigerant to be distributed only to the chiller 20b.

Therefore, when icing occurs on the surface of the outdoor heat exchanger 18 in the heat pump mode, the flow of refrigerant to the outdoor heat exchanger 18 is restricted to prevent icing from occurring on the outdoor heat exchanger 18.

Referring again to FIG. 2, the valve control part 52 is equipped with a microprocessor. When the waste heat recovery rate sufficient condition determination part 30 determines that the waste heat recovery rate for electrical components on the chiller 20b side is sufficient in the heat pump mode, and outputs a waste heat recovery rate sufficient signal S1, the valve control part 52 controls the expansion valves 18a and 22 in response to the output signal.

In particular, as shown in FIG. 3, among the expansion valves 18a and 22, the expansion valve 18a on the outdoor heat exchanger 18 side is closed, and the expansion valve 22 on the chiller 20b side is opened.

Therefore, when the waste heat recovery rate for electrical components on the chiller 20b side is sufficient in the heat pump mode, the distribution of the refrigerant to the outdoor heat exchanger 18 side is restricted, and the distribution of the refrigerant to the chiller 20b side is permitted.

Accordingly, when the waste heat recovery rate for electrical components on the chiller 20b side is sufficient in the heat pump mode, only the recovery of the waste heat (hereinafter referred to as “water heat”) from the electrical components on the chiller 20b side is permitted, and the air heat recovery from the ambient air on the outdoor heat exchanger 18 side is restricted.

As a result, when the waste heat recovery rate for electrical components on the chiller 20b side is sufficient in the heat pump mode, only the distribution of refrigerant to the chiller 20b is permitted, thereby preventing unnecessary distribution of refrigerant to the outdoor heat exchanger 18.

Accordingly, unnecessary distribution of refrigerant to the outdoor heat exchanger 18, resultant unnecessary flow path resistance and pressure loss of the refrigerant, and the resulting decrease in heating performance can be suppressed.

Referring again to FIG. 2, when the waste heat recovery rate sufficient condition determination part 30 determines that the waste heat recovery rate for electrical components on the chiller 20b side is insufficient in the heat pump mode, and outputs a waste heat recovery rate insufficient signal S2, the valve control part 52 controls the expansion valves 18a and 22 in response to the output signal.

In particular, as shown in FIG. 4, both the expansion valve 18a on the outdoor heat exchanger 18 side and the expansion valve 22 on the chiller 20b side are opened at the same time. Therefore, the refrigerant distribution to the outdoor heat exchanger 18 and the chiller 20b is permitted at the same time.

Accordingly, when the waste heat recovery rate for electrical components on the chiller 20b side is insufficient in the heat pump mode, the recovery of the water heat on the chiller 20b side and the air heat recovery from the ambient air on the outdoor heat exchanger 18 side can be performed at the same time.

Thus, when the waste heat recovery rate for electrical components on the chiller 20b side is insufficient in the heat pump mode, the waste heat of the electrical components and the heat of the ambient air can be recovered simultaneously by the refrigerant in the refrigerant circulation line 12, thereby compensating for the insufficient electric component waste heat recovery rate.

Meanwhile, the valve control part 52 variably controls the opening degree of the expansion valve 18a on the outdoor heat exchanger 18 side when distributing the refrigerant to the outdoor heat exchanger 18 under the condition that the waste heat recovery rate for electrical components on the chiller 20b side is insufficient.

In particular, the opening degree of the expansion valve 18a on the outdoor heat exchanger 18 side is variably controlled according to the superheat degree of the refrigerant at the outlet of the outdoor heat exchanger 18.

That is, the valve control part 52 receives refrigerant pressure and temperature data from the PT sensor 40 installed at the outlet of the outdoor heat exchanger 18, calculates the superheat degree of the refrigerant based on the received refrigerant pressure and temperature data, and controls the opening degree of the expansion valve 18a on the outdoor heat exchanger 18 side so that the calculated superheat degree of the refrigerant can be controlled based on a preset target superheat degree.

In particular, if the calculated superheat degree of the refrigerant at the outlet of the outdoor heat exchanger 18 exceeds the preset target superheat degree, the opening degree of the expansion valve 18a on the outdoor heat exchanger 18 side is further increased by a preset value, thereby increasing the flow rate of the refrigerant flowing toward the outdoor heat exchanger 18.

Conversely, if the calculated superheat degree of the refrigerant at the outlet of the outdoor heat exchanger 18 is smaller than the preset target superheat degree, the opening degree of the expansion valve 18a on the outdoor heat exchanger 18 side is further decreased by a preset value, thereby reducing the flow rate of the refrigerant flowing toward the outdoor heat exchanger 18.

Consequently, when the waste heat recovery rate for electrical components on the chiller 20b side is sufficient, the opening degree of the expansion valve 18a on the outdoor heat exchanger 18 side is variably controlled according to the refrigerant superheat degree at the outlet of the outdoor heat exchanger 18, and is controlled in conformity with the condition in which the refrigerant superheat degree converges to a target superheat degree.

Referring again to FIG. 2, the vehicular heat management system according to the present invention further includes an icing occurrence determination part 60 that determines whether icing occurs on the surface of the outdoor heat exchanger 18.

The icing occurrence determination part 60 is equipped with a microprocessor. In the heat pump mode, the icing occurrence determination part 60 receives the refrigerant temperature T1 and the outside air temperature T2, which are factors affecting the occurrence of icing on the surface of the outdoor heat exchanger 18, from the PT sensor 40 at the outlet of the outdoor heat exchanger 18 and the outside air sensor (not shown), respectively.

Then, the refrigerant temperature T1, the outside air temperature T2, and a preset icing occurrence determination reference temperature difference T4 are compared. Determination as to whether icing occurs on the surface of the outdoor heat exchanger 18 is made depending on whether preset conditions are all satisfied.

That is, it is determined whether a [third condition] that the refrigerant temperature T1 at the outlet of the outdoor heat exchanger 18 is equal to or lower than the outside air temperature T2 as denoted below and a [fourth condition] that a temperature difference between the refrigerant temperature T1 at the outlet of the outdoor heat exchanger 18 and the outside air temperature T2 is equal or greater than the preset icing occurrence determination reference temperature difference T4 as denoted below are satisfied.

### Third Condition

Outdoor heat exchanger outlet refrigerant temperature T1≤outside air temperature T2

### Fourth Condition

Outdoor heat exchanger outlet refrigerant temperature T1−outside air temperature T2≥icing occurrence determination reference temperature difference T4

If the [third condition] and the [fourth condition] are all satisfied, the icing occurrence determination part 30 determines that icing occurs on the surface of the outdoor heat exchanger 18 in view of the fact that the refrigerant temperature at the outlet of the outdoor heat exchanger 18 is currently equal to or lower than the outside air temperature by a preset value or more, and outputs an icing occurrence signal S3 to the valve control part 52 of the refrigerant distribution amount control part 50 based on this determination.

On the other hand, if either of the [third condition] and the [fourth condition] is not satisfied, it is determined that icing does not occur on the surface of the outdoor heat exchanger 18, and the icing occurrence signal S3 is canceled based on this determination.

Meanwhile, the valve control part 52 of the refrigerant distribution amount control part 50 controls the expansion valve 18a on the outdoor heat exchanger 18 side and the expansion valve 22 on the chiller 20b side when it is determined that icing occurs on the surface of the outdoor heat exchanger 18 in the heat pump mode.

In particular, as shown in FIG. 5, the expansion valve 18a on the outdoor heat exchanger 18 side is closed, and the expansion valve 22 on the chiller 20b side is opened.

Therefore, when icing occurs on the surface of the outdoor heat exchanger 18 in the heat pump mode, the refrigerant distribution to the outdoor heat exchanger 18 is restricted, and the refrigerant distribution to the chiller 20b is permitted.

Accordingly, when icing occurs on the surface of the outdoor heat exchanger 18 in the heat pump mode, the refrigerant flow toward the outdoor heat exchanger 18 is restricted, thereby preventing icing from occurring on the outdoor heat exchanger 18.

Next, an operation example of the vehicular heat management system according to the present invention having such a configuration will be described in detail with reference to FIGS. 2 to 6.

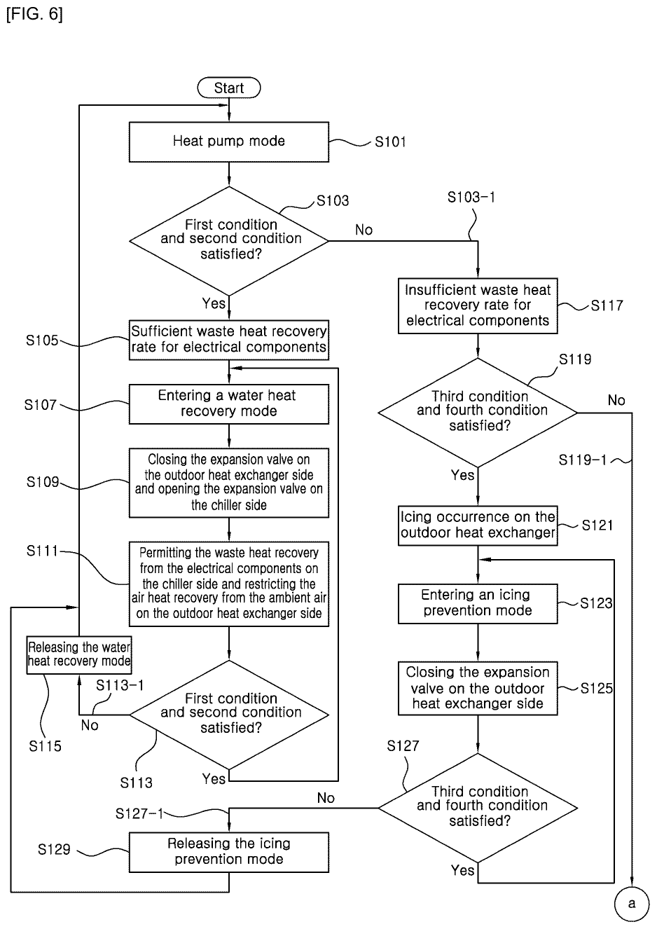

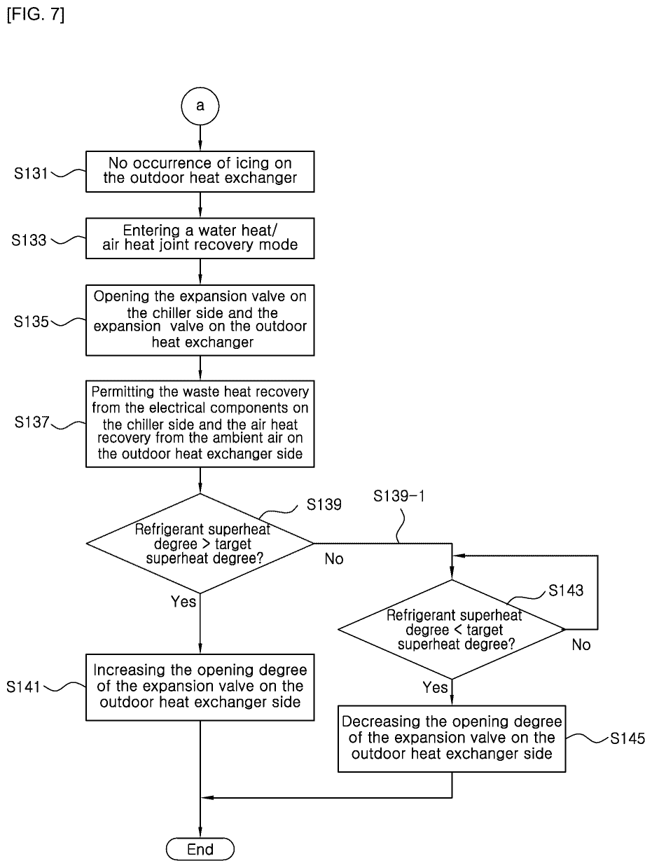

Referring first to FIGS. 2 and 6, in the heat pump mode (S101), the waste heat recovery rate sufficient condition determination part 30 compares the refrigerant temperature T1 inputted from the PT sensor 40 at the outlet of the outdoor heat exchanger 18, the outside air temperature T2 inputted from the outside air sensor, and the preset waste heat recovery rate determination reference temperature difference T3 to determine whether the [first condition] and the [second condition] are all satisfied (S103).

That is, it is determined whether the [first condition] in which the refrigerant temperature T1 at the outlet of the outdoor heat exchanger 18 is equal to or higher than the outside air temperature T2 and the [second condition] in which the temperature difference between the refrigerant temperature T1 at the outlet of the outdoor heat exchanger 18 and the outside air temperature T2 is equal to or greater than the waste heat recovery rate determination reference temperature difference T3 are all satisfied.

If the [first condition] and the [second condition] are satisfied, the waste heat recovery rate sufficient condition determination part 30 determines that the waste heat recovery rate for electrical components on the chiller 20b side is sufficient and equal to or greater than a preset value (S105).

If the waste heat recovery rate for electrical components on the chiller 20b side is determined to be sufficient, the valve control part 52 of the refrigerant distribution amount control part 50 enters a water heat recovery mode (S107).

The valve control part 52, which has entered the water heat recovery mode, closes the expansion valve 18a on the outdoor heat exchanger 18 side and opens the expansion valve 22 on the chiller 20b side (S109).

Then, as shown in FIGS. 3 and 6, the refrigerant distribution to the outdoor heat exchanger 18 is restricted, and only the refrigerant distribution to the chiller 20b is permitted.

As a result, when the waste heat recovery rate for electrical components on the chiller 20b side is sufficient in the heat pump mode, only the waste heat recovery from the electrical components on the chiller 20b side is permitted, and the air heat recovery from the ambient air on the outdoor heat exchanger 18 side is restricted (S111).

Meanwhile, while restricting the refrigerant distribution to the outdoor heat exchanger 18, the waste heat recovery rate sufficient condition determination part 30 continuously compares the refrigerant temperature T1, the outside air temperature T2,and the waste heat recovery rate determination reference temperature difference T3 to continuously monitor whether both the [first condition] and the [second condition] described above are satisfied (S113).

If any one of the [first condition] and the [second condition] is not satisfied (S113-1), the valve control part 52 releases the water heat recovery mode (S115) and returns the expansion valve 18a on the outdoor heat exchanger 18 side and the expansion valve 22 on the chiller 20b side to their original states (S101).

Referring again to FIGS. 2 and 6, if any one of the [first condition] and [second condition] is not satisfied as a result of the determination in step S103, the waste heat recovery rate sufficient condition determination part 30 determines that the waste heat recovery rate for electrical components on the chiller 20b side is insufficient and smaller than the preset value (S117).

If the waste heat recovery rate for electrical components on the chiller 20b side is determined to be insufficient, the icing occurrence determination part 60 compares the refrigerant temperature T1 inputted from the PT sensor 40 at the outlet of the outdoor heat exchanger 18, the outside air temperature T2 inputted from the outside air sensor, and the preset icing occurrence determination reference temperature difference T4 to determine whether the [third condition] and the [fourth condition] described above are all satisfied (S119).

That is, it is determined whether the [third condition] in which the refrigerant temperature T1 at the outlet of the outdoor heat exchanger 18 is equal to or lower than the outside air temperature T2 and the [fourth condition] in which the temperature difference between the refrigerant temperature T1 at the outlet of the outdoor heat exchanger 18 and the outside air temperature T2 is equal to or higher than the icing occurrence determination reference temperature difference T4 are all satisfied.

If the [third condition] and the [fourth condition] are all satisfied, the icing occurrence determination part 60 determines that icing occurs on the surface of the outdoor heat exchanger 18 (S121).

If the icing occurrence on the outdoor heat exchanger 18 is determined, the valve control part 52 of the refrigerant distribution amount control part 50 enters an icing prevention mode (S123).

The valve control part 52, which has entered the icing prevention mode, closes the expansion valve 18a on the outdoor heat exchanger 18 side, as shown in FIGS. 5 and 6(S 125 ).

Then, the refrigerant distribution to the outdoor heat exchanger 18 is restricted, thereby preventing the occurrence of icing on the outdoor heat exchanger 18.

Meanwhile, while restricting the refrigerant distribution to the outdoor heat exchanger 18, the icing occurrence determination part 60 continuously compares the refrigerant temperature T1, the outside air temperature T2, and the icing occurrence determination reference temperature difference T4 to continuously monitor whether the [third condition] and the [fourth condition] described above are all satisfied (S127).

If any one of the [third condition] and the [fourth condition] is not satisfied (S127-1), the valve control part 52 releases the icing prevention mode (S129) and returns the expansion valve 18a on the outdoor heat exchanger 18 side to its original state (S101).

Referring again to FIGS. 2 and 6, if the determination result in step S119 indicates that either of the [third condition] and the [fourth condition] is not satisfied (S119-1), the icing occurrence determination part 60 determines that icing does not occur on the surface of the outdoor heat exchanger 18 (S131).

If it is determined that icing of the outdoor heat exchanger 18 has not occurred, the valve control part 52 enters a water heat and air heat joint recovery mode (S133).

Then, the valve control part 52 that has entered the water heat and air heat joint recovery mode simultaneously opens the expansion valve 18a on the outdoor heat exchanger 18 side and the expansion valve 22 on the chiller 20b side (S135).

Then, as shown in FIGS. 4 and 6, the refrigerant distribution to the outdoor heat exchanger 18 and the refrigerant distribution to the chiller 20b are permitted simultaneously.

As a result, when the waste heat recovery rate for electrical components on the chiller 20b side is insufficient in the heat pump mode, the waste heat recovery from the electric components on the chiller 20b side and the air heat recovery on the outdoor heat exchanger 18 side are permitted simultaneously (S137).

Meanwhile, in a state in which the refrigerant distribution to the outdoor heat exchanger 18 and the refrigerant distribution to the chiller 20b are permitted simultaneously, the valve control part 52 determines whether the refrigerant superheat degree calculated based on the refrigerant pressure and temperature data inputted from the PT sensor 40 at the outlet of the outdoor heat exchanger 18 exceeds the preset target superheat degree (S139).

If the refrigerant superheat degree exceeds the target superheat degree, the valve control part 52 further increases the opening degree of the expansion valve 18a on the outdoor heat exchanger 18 side by a preset value (S141).

Then, as the flow rate of the refrigerant flowing toward the outdoor heat exchanger 18 increases, the refrigerant superheat degree at the outlet of the outdoor heat exchanger 18 decreases.

Meanwhile, if the result of determination in step S139 indicates that the refrigerant superheat degree at the outlet of the outdoor heat exchanger 18 does not exceed the target superheat degree (S139-1), the valve control part 52 determines whether the refrigerant superheat degree at the outlet of the outdoor heat exchanger 18 is smaller than the target superheat degree (S143).

If the refrigerant superheat degree is smaller than the target superheat degree, the valve control part 52 further reduces the opening degree of the expansion valve 18a on the outdoor heat exchanger 18 side by a preset value (S145).

Then, as the flow rate of the refrigerant flowing toward the outdoor heat exchanger 18 decreases, the refrigerant superheat degree at the outlet of the outdoor heat exchanger 18 increases.

According to the vehicular heat management system of the present invention having such a configuration, in the heat pump mode, the amount of refrigerant distributed to the outdoor heat exchanger 18 and the chiller 20b can be adjusted depending on the state of the refrigerant and the air conditioning conditions. Therefore, the distribution of the refrigerant to an unnecessary part among the outdoor heat exchanger 18 and the chiller 20b can be restricted depending on the conditions.

In particular, under conditions where the waste heat recovery rate for the electrical components on the chiller 20b side is sufficient, refrigerant distribution to the outdoor heat exchanger 18 is restricted, and refrigerant distribution only to the chiller 20b is permitted. Therefore, unnecessary refrigerant distribution to the outdoor heat exchanger 18 can be prevented when the waste heat recovery rate for the electrical components on the chiller 20b side is sufficient.

Therefore, the unnecessary refrigerant flow path resistance and pressure loss due to unnecessary refrigerant distribution to the outdoor heat exchanger 18 and the resulting decrease in heating performance can be suppressed.

In addition, in the heat pump mode, under the condition of occurrence of icing on the surface of the outdoor heat exchanger 18, the distribution of refrigerant to the outdoor heat exchanger 18 is restricted, and the distribution of refrigerant to the chiller 20b is permitted.

Therefore, when icing occurs on the surface of the outdoor heat exchanger 18, the flow of refrigerant to the outdoor heat exchanger 18 is restricted, thereby fundamentally preventing the occurrence of icing on the outdoor heat exchanger 18.

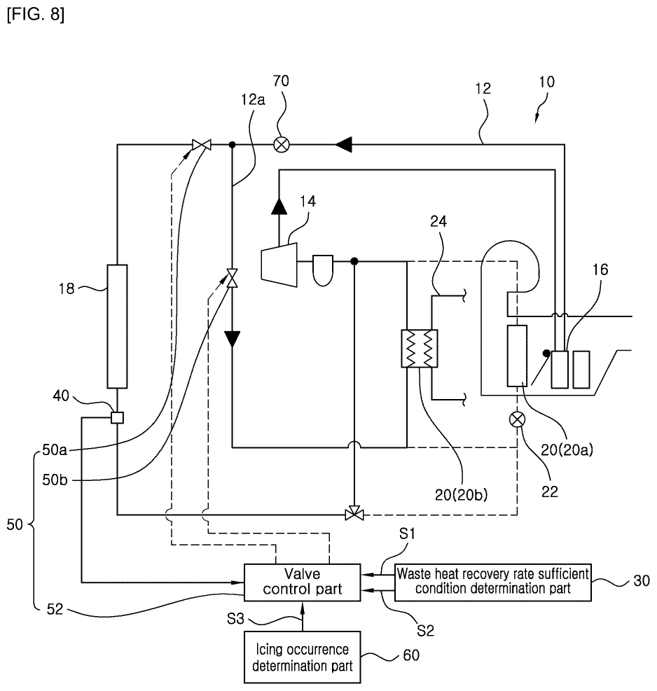

Next, a vehicular heat management system according to another embodiment of the present invention will be described with reference to FIG. 8.

The heat management system according to another embodiment of the present invention includes an expansion valve 70 for depressurizing and expanding the refrigerant introduced into the outdoor heat exchanger 18 and the chiller 20b. The expansion valve 70 is installed as a single unit on the common refrigerant circulation line 12 upstream of the outdoor heat exchanger 18 and the chiller 20b.

The expansion valve 70 installed on the common refrigerant circulation line 12 upstream of the outdoor heat exchanger 18 and the chiller 20b depressurizes and expands the refrigerant introduced into the outdoor heat exchanger 18 and the chiller 20b in the heat pump mode.

Accordingly, cold air is generated in the outdoor heat exchanger 18 and the chiller 20b. The cold air generated in the outdoor heat exchanger 18 can exchange heat with the ambient air, and the cold air generated in the chiller 20b can exchange heat with the cooling water in the cooling water circulation line 24.

This allows the air heat in the outdoor heat exchanger 18 and the waste heat of the electrical components in the chiller 20b to be recovered to the refrigerant in the refrigerant circulation line 12.

As in the above-described embodiment, the heat management system according to another embodiment of the present invention illustrated in FIG. 8 includes a refrigerant distribution amount control part 50 capable of adjusting the amount of refrigerant distributed to the outdoor heat exchanger 18 and the chiller 20b according to conditions in the heat pump mode.

The refrigerant distribution amount control part 50 includes a flow rate control on-off valve 50a installed on the upstream side of the outdoor heat exchanger 18, a flow rate control on-off valve 50b installed on the upstream side of the chiller 20b, and a valve control part 52 that controls the on-off valves 50a and 50b.

The refrigerant distribution amount control part 50 controls the on-off valves 50a and 50b so that when the waste heat recovery rate for electrical components on the chiller 20b side is sufficient in the heat pump mode, the refrigerant distribution to the outdoor heat exchanger 18 is restricted and the refrigerant distribution to the chiller 20b is permitted.

Therefore, when the waste heat recovery rate for electrical components on the chiller 20b side is sufficient in the heat pump mode, only the waste heat recovery from the electrical components on the chiller 20b side is permitted and the air heat recovery from the ambient air on the outdoor heat exchanger 18 side is restricted.

In addition, the refrigerant distribution amount control part 50 controls the on-off valves 50a and 50b so that refrigerant distribution to the outdoor heat exchanger 18 and the chiller 20b can be performed simultaneously when the waste heat recovery rate for electrical components on the chiller 20b side is insufficient in the heat pump mode.

Therefore, when the waste heat recovery rate for electrical components on the chiller 20b side is insufficient in the heat pump mode, the waste heat recovery from the electrical components on the chiller 20b side and the air heat recovery from the ambient air on the outdoor heat exchanger 18 side can be performed simultaneously.

In addition, the refrigerant distribution amount control part 50 controls the on-off valves 50a and 50b so as to restrict the refrigerant distribution to the outdoor heat exchanger 18 when icing occurs on the surface of the outdoor heat exchanger 18 in the heat pump mode, thereby preventing icing from occurring on the outdoor heat exchanger 18.

In addition, the refrigerant distribution amount control part 50 variably controls the opening degree of the flow rate control on-off valve 50a on the outdoor heat exchanger 18 side when distributing the refrigerant to the outdoor heat exchanger 18 under the condition that the waste heat recovery rate for electrical components on the chiller 20b side is insufficient in the heat pump mode.

In particular, the opening degree of the flow rate control on-off valve 50a on the outdoor heat exchanger 18 side is variably controlled according to the superheat degree of the refrigerant at the outlet of the outdoor heat exchanger 18.

That is, the refrigerant distribution amount control part 50 increases the opening degree of the flow rate control on-off valve 50a on the outdoor heat exchanger 18 side by a preset value when the superheat degree of the refrigerant at the outlet of the outdoor heat exchanger 18 exceeds a preset target superheat degree under the condition that the waste heat recovery rate for electrical components on the chiller 20b side is sufficient in the heat pump mode, thereby increasing the flow rate of the refrigerant flowing toward the outdoor heat exchanger 18.

On the other hand, if the refrigerant superheat degree at the outlet of the outdoor heat exchanger 18 is smaller than the preset target superheat degree, the opening degree of the flow rate control on-off valve 50a on the outdoor heat exchanger 18 side is further reduced by a preset value, thereby reducing the flow rate of the refrigerant flowing to the outdoor heat exchanger 18.

Accordingly, the opening degree of the flow rate control on-off valve 50a on the outdoor heat exchanger 18 side is changed according to the refrigerant superheat degree at the outlet of the outdoor heat exchanger 18, and is controlled in conformity with the condition that the refrigerant superheat degree converges to the preset target superheat degree.

The refrigerant distribution amount control part 50 of another embodiment illustrated in FIG. 8 has the same structure and operation logic as the refrigerant distribution amount control part 50 of the above-described embodiment, except for the structure described above.

In particular, the refrigerant distribution amount control part 50 of another embodiment has the same structure and logic as the refrigerant distribution amount control part 50 of the above-described embodiment, which adjusts the refrigerant distribution amount for the outdoor heat exchanger 18 and the chiller 20b according to conditions.

Therefore, a detailed description of the structure and operation of the refrigerant distribution amount control part 50 of another embodiment illustrated in FIG. 8 is omitted.

While the preferred embodiment of the present invention has been described above by way of example, the scope of the present invention is not limited to such a specific embodiment, and may be appropriately changed within the scope recited in the claims.

1. A vehicular heat management system, comprising:
a heat pump type refrigerant circulation line including a compressor, a high pressure side heat exchanger, and an outdoor heat exchanger and a chiller connected in parallel to each other; and
a refrigerant distribution amount control part configured to control an amount of refrigerant distributed to the outdoor heat exchanger and the chiller according to air conditioning conditions in a heat pump mode.

2. The system of claim 1, wherein the chiller is configured to, in the heat pump mode, allow the refrigerant in the refrigerant circulation line to exchange heat with cooling water in a cooling water circulation line for cooling electrical components, so that waste heat of the electrical components absorbed to the cooling water is recovered to the refrigerant in the refrigerant circulation line, and
the refrigerant distribution amount control part is configured to, in the heat pump mode, variably control the amount of refrigerant distributed to the outdoor heat exchanger and the chiller according to a waste heat recovery rate of the refrigerant for the electrical components on the chiller side.

3. The system of claim 2, further comprising:
a waste heat recovery rate sufficient condition determination part configured to, in the heat pump mode, determines whether the waste heat recovery rate of the refrigerant for the electrical components on the chiller side is sufficient and equal to or greater than a preset value or insufficient and smaller than the preset value,
wherein the refrigerant distribution amount control part is configured to, in the heat pump mode, variably control the refrigerant distribution to the outdoor heat exchanger and the chiller according to a result of determination by the waste heat recovery rate sufficient condition determination part as to whether the waste heat recovery rate of the refrigerant for the electrical components on the chiller side is sufficient or insufficient.

4. The system of claim 3, wherein if the waste heat recovery rate sufficient condition determination part determines that the waste heat recovery rate of the refrigerant for the electrical components on the chiller side is sufficient, the refrigerant distribution amount control part restricts the refrigerant distribution to the outdoor heat exchanger and permits the refrigerant distribution to the chiller, so that only the waste heat recovery from the electrical components on the chiller side is performed while restricting the air heat recovery from ambient air on the outdoor heat exchanger side.

5. The system of claim 4, wherein if the waste heat recovery rate sufficient condition determination part determines that the waste heat recovery rate of the refrigerant for the electrical components on the chiller side is insufficient, the refrigerant distribution amount control part simultaneously permits the refrigerant distribution to the outdoor heat exchanger and the refrigerant distribution to the chiller, so that the waste heat recovery from the electrical components on the chiller side and the air heat recovery from the ambient air on the outdoor heat exchanger side are performed at the same time.

6. The system of claim 5, further comprising:
an expansion valve configured to depressurizing and expanding the refrigerant introduced into the outdoor heat exchanger in the heat pump mode,
wherein when distributing the refrigerant to the outdoor heat exchanger under the condition that the waste heat recovery rate of the refrigerant for the electrical components on the chiller side is insufficient, the refrigerant distribution amount control part variably controls an opening degree of the expansion valve on the outdoor heat exchanger side according to a refrigerant superheat degree of at an outlet of the outdoor heat exchanger.

7. The system of claim 6, wherein the refrigerant distribution amount control part increases the opening degree of the expansion valve by a preset value when the refrigerant superheat degree at the outlet of the outdoor heat exchanger exceeds the preset target superheat degree, and decreases the opening degree of the expansion valve by a preset value when the refrigerant superheat degree at the outlet of the outdoor heat exchanger is smaller than the preset target superheat degree.

8. The system of claim 7, further comprising:
an icing occurrence determination part configured to determine whether icing occurs on a surface of the outdoor heat exchanger in the heat pump mode,
wherein when the icing occurrence determination part determines that icing occurs on the surface of the outdoor heat exchanger in the heat pump mode, the refrigerant distribution amount control part restricts the refrigerant distribution to the outdoor heat exchanger and permits the refrigerant distribution to the chiller so as to prevent icing occurrence on the outdoor heat exchanger.

9. The system of claim 8, wherein the refrigerant distribution amount control part includes electromagnetic expansion valves installed on the upstream side of the outdoor heat exchanger and the chiller and configured to depressurize and expand the refrigerant introduced into the outdoor heat exchanger and the chiller, and a valve control part configured to control opening degrees of the electromagnetic expansion valves depending on whether the waste heat recovery rate of the refrigerant for the electrical components on the chiller side is sufficient or insufficient,
when the waste heat recovery rate of the refrigerant for the electrical components on the chiller side is sufficient, the valve control part closes the expansion valve on the outdoor heat exchanger side and opens the expansion valve on the chiller side so as to restrict the refrigerant distribution to the outdoor heat exchanger and permit the refrigerant distribution to the chiller, and
when the waste heat recovery rate of the refrigerant for the electrical components on the chiller side is insufficient, the valve control part opens the expansion valve on the outdoor heat exchanger side and the expansion valve on the chiller side so as to permit the refrigerant distribution to the outdoor heat exchanger and the refrigerant distribution to the chiller at the same time.

10. The system of claim 9, wherein when opening the expansion valve on the outdoor heat exchanger side under the condition that the waste heat recovery rate of the refrigerant for the electrical components on the chiller side is insufficient, the valve control part variably controls the opening degree of the expansion valve according to the refrigerant superheat degree at the outlet of the outdoor heat exchanger.

11. The system of claim 10, wherein if it is determined that icing has occurred on the surface of the outdoor heat exchanger in the heat pump mode, the valve control part closes the expansion valve on the outdoor heat exchanger side and opens the expansion valve on the chiller side so as to restrict the refrigerant distribution to the outdoor heat exchanger and permit the refrigerant distribution to the chiller.

12. The system of claim 11, wherein the waste heat recovery rate sufficient condition determination part compares refrigerant temperature T1, outside air temperature T2, and a preset waste heat recovery rate determination reference temperature difference T3 in the heat pump mode to determine whether a [first condition] that outdoor heat exchanger outlet refrigerant temperature T1≥outside air temperature T2 and a [second condition] that outdoor heat exchanger outlet refrigerant temperature T1−outside air temperature T2≥waste heat recovery rate determination reference temperature difference T3 are satisfied,
if the [first condition] and the [second condition] are all satisfied, the waste heat recovery rate sufficient condition determination part determines that the waste heat recovery rate for the electrical components on the chiller side is sufficient and equal to or greater than the preset value, and
if either of the [first condition] and the [second condition] is not satisfied, the waste heat recovery rate sufficient condition determination part determines that the waste heat recovery rate for the electrical components on the chiller side is insufficient and smaller than the preset value.

13. The system of claim 12, wherein the icing occurrence determination part compares the refrigerant temperature T1, the outside air temperature T2, and a preset icing occurrence determination reference temperature difference T4 to determine whether a [third condition] that outdoor heat exchanger outlet refrigerant temperature T1≤outside air temperature T2 and a [fourth condition] that outdoor heat exchanger outlet refrigerant temperature T1−outside air temperature T2≥icing occurrence determination reference temperature difference T4 are satisfied, if the [third condition] and the [fourth condition] are all satisfied, the icing occurrence determination part determines that icing occurs on the surface of the outdoor heat exchanger, and
if either of the [third condition] and the [fourth condition] is not satisfied, the icing occurrence determination part determines that icing does not occur on the surface of the outdoor heat exchanger.

14. The system of claim 5, wherein the refrigerant distribution amount control part includes an on-off valve installed on the upstream side of the outdoor heat exchanger, an on-off valve installed on the upstream side of the chiller, and a valve control part configured to control the on-off valves depending on whether the waste heat recovery rate of the refrigerant for the electrical components on the chiller side is sufficient or insufficient,
when the waste heat recovery rate of the refrigerant for the electrical components on the chiller side is sufficient, the valve control part closes the on-off valve on the outdoor heat exchanger side and opens the on-off valve on the chiller side so as to restrict the refrigerant distribution to the outdoor heat exchanger and permit the refrigerant distribution to the chiller, and
when the waste heat recovery rate of the refrigerant for the electrical components on the chiller side is insufficient, the valve control part opens the on-off valve on the outdoor heat exchanger side and the on-off valve on the chiller side so as to permit the refrigerant distribution to the outdoor heat exchanger and the refrigerant distribution to the chiller at the same time.

15. The system of claim 14, further comprising:
an icing occurrence determination part configured to determine whether icing occurs on a surface of the outdoor heat exchanger in the heat pump mode,
wherein when the icing occurrence determination part determines that icing occurs on the surface of the outdoor heat exchanger in the heat pump mode, the valve control part closes the on-off valve on the outdoor heat exchanger side and opens the on-off valve on the chiller side so as to restrict the refrigerant distribution to the outdoor heat exchanger and permit the refrigerant distribution to the chiller.

16. The system of claim 15, wherein the waste heat recovery rate sufficient condition determination part compares refrigerant temperature T1, an outside air temperature T2, and a preset waste heat recovery rate determination reference temperature difference T3 in the heat pump mode to determine whether a [first condition] that outdoor heat exchanger outlet refrigerant temperature T1≥outside air temperature T2 and a [second condition] that outdoor heat exchanger outlet refrigerant temperature T1−outside air temperature T2≥waste heat recovery rate determination reference temperature difference T3 are satisfied,
if the [first condition] and the [second condition] are all satisfied, the waste heat recovery rate sufficient condition determination part determines that the waste heat recovery rate for the electrical components on the chiller side is sufficient and equal to or greater than the preset value, and
if either of the [first condition] and the [second condition] is not satisfied, the waste heat recovery rate sufficient condition determination part determines that the waste heat recovery rate for the electrical components on the chiller side is insufficient and smaller than the preset value.

17. The system of claim 16, wherein the icing occurrence determination part compares the refrigerant temperature T1, the outside air temperature T2, and a preset icing occurrence determination reference temperature difference T4 to determine whether a [third condition] that outdoor heat exchanger outlet refrigerant temperature T1≤outside air temperature T2 and a [fourth condition] that outdoor heat exchanger outlet refrigerant temperature T1−outside air temperature T2≥icing occurrence determination reference temperature difference T4 are satisfied,
if the [third condition] and the [fourth condition] are all satisfied, the icing occurrence determination part determines that icing occurs on the surface of the outdoor heat exchanger, and
if either of the [third condition] and the [fourth condition] is not satisfied, the icing occurrence determination part determines that icing does not occur on the surface of the outdoor heat exchanger.
